(19) United States
(12) Patent Application Publication
(10) Pub. No.: US 2007/0277386 A1
(43) Pub. Date: Dec. 6, 2007

(54) INCLINOMETER OR TILT SWITCH WITH REFINED MOTION SENSITIVITY

(75) Inventors: Stephen O. Bozzone, Lauderhill, FL (US); James L. Tracy, Coral Springs, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/421,148

(22) Filed: May 31, 2006

(51) Int. Cl. G01C 9/12

(52) U.S. Cl. 33/391

(57) ABSTRACT

An inclinometer (600) can include a first housing portion (400) having a sloped surface (402) including plurality of conductive areas or surfaces (401, 415, 430, 445, 460, 416, 431, 446, and 461) on the sloped surface, and a second sloped surface (404) having a common contact (480) separate from the conductive areas. The conductive areas can be a plurality of conductive areas corresponding for example to tilt degrees of 0, 15, 30, 45, and 60 respectively in a left orientation and 0, 15, 30, 45, and 60 respectively in a right orientation. The inclinometer can include a housing (602) that mates with the first housing portion and encloses the first housing portion and a conductive substantially spherical element or ball (700) therein. The ball can traverse the sloped surface and form a connection between the common contact and the at least one conductive portion as it traverses the sloped surface.

### FIELD

This invention relates generally to tilt switches and inclinometers, more particularly to tilt switches and inclinometers having sloped surfaces.

### BACKGROUND

Consumer devices such as phones, personal digital assistants and toys can benefit from low cost methods to determine orientation of a device. Unfortunately, gyros, inertial switches and accelerometers are expensive alternatives and Mercury switches are typically environmentally unfriendly. Various techniques using a metal ball exist, but none simply distinguish orientation or provide a measure of degree of tilt. Many of the known techniques merely provide an on/off function. Some techniques using a ball sense changes in capacitance, but again fail to provide a measure of degree of tilt or orientation.

### SUMMARY

Embodiments in accordance with the present invention can provide a conductive spherical or spherical like implementation for a tilt switch or inclinometer or a remote controller or system that can simply provide a measure of tilt or orientation.

In a first embodiment of the present invention, an inclinometer can include a sloped surface having at least one conductive portion on opposing sides of the sloped surface, a second sloped surface having a common contact separate from the at least one conductive portion, and a conductive substantially spherical member that traverses the sloped surface. The conductive substantially spherical element forms a connection between the common contact and the at least one conductive portion as it traverses the sloped surface. The conductive substantially spherical element or member can be dimpled or shaped or formed to add additional friction as it traverses the sloped surface and does not necessarily need to be in the shape of a sphere as long the member creates the appropriate connections as it traverses or rolls along the sloped surface. The sloped surface can be a curved surface having a plurality of conductive portions along the curved surface and the second sloped surface can be a curved surface having a conductive surface thereon forming the common contact. The inclinometer can further include a housing having a first housing portion holding the at least one conductive portion and the common contact and a second housing portion which defines a path for the conductive substantially spherical member to traverse when the first housing portion and the second housing portion are mated which can substantially limit the sphere member from deviating from the path. The second housing portion can further include a surface creating friction upon the conductive substantially spherical member as it traverses the path. The inclinometer can further include a controller coupled to the plurality of conductive portions and the common contact where connections between select portions of the plurality of conductive portions and the common contact creates an indication of a degree of tilt recognizable by the controller. The inclinometer can further include an electrical connection scheme such as a wire harness that can provide a coupling between the controller and the plurality of conductive portions and the common contact. The inclinometer can further include a cover to cover the wire harness.

In a second embodiment of the present invention, a remote controller for controlling a remote controlled device can include a transmitter, a controller coupled to the transmitter, a sloped surface having at least one conductive portion on opposing sides of the sloped surface, a second sloped surface having a common contact separate from the at least one conductive portion, and a conductive substantially spherical member that traverses the sloped surface. The conductive substantially spherical member can be dimpled or formed or shaped to add friction to the member as it traverses the sloped surface. The conductive substantially spherical element can form a connection between the common contact and the at least one conductive portion as it traverses the sloped surface. The sloped surface can be a curved surface having a plurality of conductive portions along the curved surface and the second sloped surface can be a curved surface having a conductive surface thereon forming the common contact. The controller can be coupled to the plurality of conductive portions and the common contact where connections between select portions of the plurality of conductive portions and the common contact creates an indication of a degree of tilt recognizable by the controller. The remote controller can further include a housing having a first housing portion holding the at least one conductive portion and the common contact and a second housing portion which defines a path for the conductive substantially spherical member to traverse when the first housing portion and the second housing portion are mated. The second housing portion can further include a surface creating friction upon the conductive substantially spherical member as it traverses the path. The remote controller can further include an electrical connection scheme such as a wire harness that provides a coupling between the controller and the plurality of conductive portions and the common contact.

In a third embodiment of the present invention, a remote controlled system having a remote controller for controlling a remote controlled device can include a transmitter, a controller coupled to the transmitter, a sloped surface having a plurality of conductive portions along a side of the sloped surface, a second sloped surface having a common contact separate from the plurality of conductive portions, and a conductive substantially spherical member that traverses the sloped surface and the second sloped surface. The conductive substantially spherical element can form a connection between the common contact and select portions of the plurality of conductive portions as it traverses the sloped surface. The controller can be coupled to the plurality of conductive portions and the common contact where connections between select portions of the plurality of conductive portions and the common contact creates an indication of a degree of tilt recognizable by the controller. The transmitter can transmit the indication of the degree of tilt to the remote controlled device to cause the remote controlled device to operate in correspondence with the indication of the degree of tilt. The remote controller can further include a housing having a first housing portion holding the plurality of conductive portions and the common contact and a second housing portion which defines a path for the conductive substantially spherical member to traverse when the first housing portion and the second housing portion are mated.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a inclinometer in accordance with an embodiment of the present invention.

FIG. 2 is an illustration of another inclinometer in accordance with an embodiment of the present invention.

FIG. 3 is an exploded view of the inclinometer of FIG. 2, further including a top housing in accordance with an embodiment of the present invention.

FIG. 4 is an interior view of an inclinometer used in a remote control system in accordance with an embodiment of the present invention.

FIG. 5 is another view of the inclinometer of FIG. 4 further including a cover such as a wire harness cover in accordance with an embodiment of the present invention.

FIG. 6 is a perspective view of a remote controller using the inclinometer of FIG. 4 in accordance with an embodiment of the present invention.

FIG. 7 is a blown-up view of a portion of the remote controller of FIG. 6 in accordance with an embodiment of the present invention.

FIG. 8 is a transparent view of the remote controller of FIG. 6 demonstrating the inclinometer in a neutral or zero degree position in accordance with an embodiment of the present invention.

FIG. 9 is another transparent view of the remote controller of FIG. 6 demonstrating the inclinometer in a 45 degree tilt position to a left orientation in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

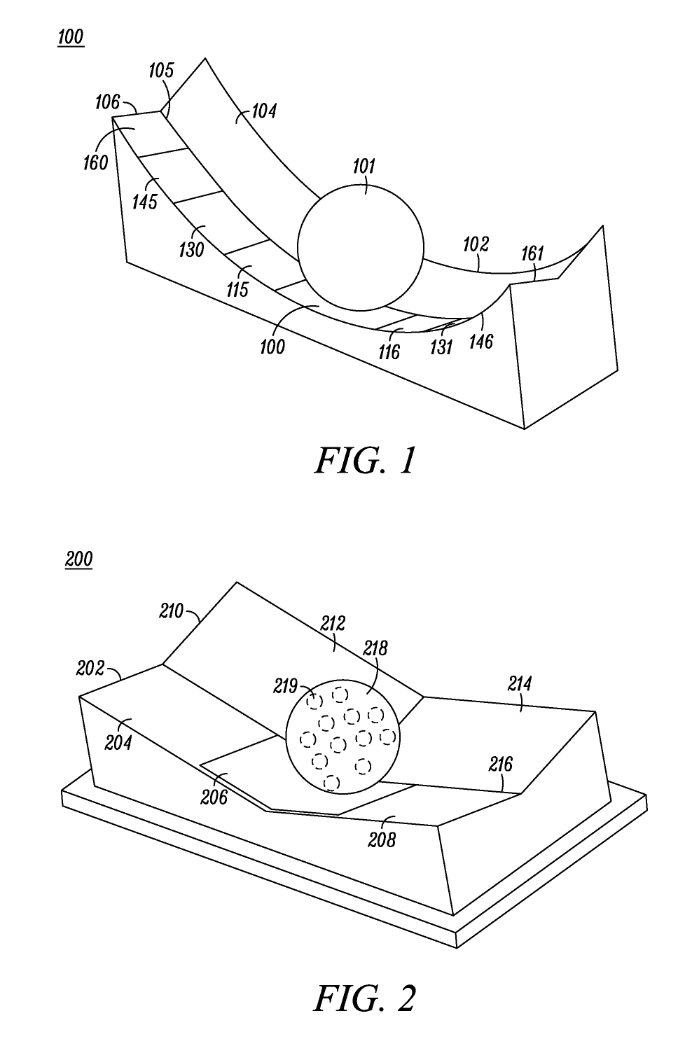

Embodiments herein can be implemented in a wide variety of ways. Referring to FIG. 1, embodiments can include a low cost inclinometer 10 that uses a conductive substantially spherical member such as a rolling conductive metal ball or sphere 101 to act as a switch contact. Note, the conductive substantially spherical member does not necessarily need to be a ball, but can come in any particular shape that traverses a sloped surface providing the functions described herein. The inclinometer 10 can determine gradual incremental changes in orientation when the inclinometer is slightly tilted from a horizontal position. As the ball 101 rolls across a sloped surface 106 (which can be a curved, concave, linear, elliptical, parabolic, or almost any other shaped track fitted with a series of spaced adjacent contacts or conductive areas that can be defined by an equation or otherwise), it hits multiple contact points. As the inclinometer 10 is tilted right and the ball 101 rolls to the right, the ball contacts contact points 100, 116, 131, 146, and 161 corresponding to zero, 15, 30, 45, and 60 degrees to the right. As the inclinometer 10 is tilted left and the ball 101 rolls to the left, the ball 101 contacts a plurality of conductive areas or contact points 100, 115, 130, 145, and 160 corresponding to zero, 15, 30, 45, and 60 degrees to the left. In this embodiment, the inclinometer 10 includes a second sloped surface 102 that has a conductive area or surface 104 that serves as a common contact. The common contact or conductive area or surface 104 is separated from the plurality of conductive areas (or surfaces) on the slope surface 106 by a non-conductive gap 105. Note, that the degrees of tilt are not limited to the ones illustrated in this example, but can be tailored to other degrees (in varying increments) of tilt based on the shape of the sloped surface(s).

Tilting an electronic device having the inclinometer 10 causes the ball 101 to roll gradually and subsequently results in a varying indication of the degree of tilt. This can serve as a useful method for user input to an electronic device such as a remote controlled vehicle controller where the user tilts the controller to drive the vehicle left and right, forward and back, or a personal digital assistant, a navigation device (such as a GPS receiver unit), electronic book or cell phone, where a user can tilt the device left or right to flip pages, scroll through a map, or traverse through menus on a device.

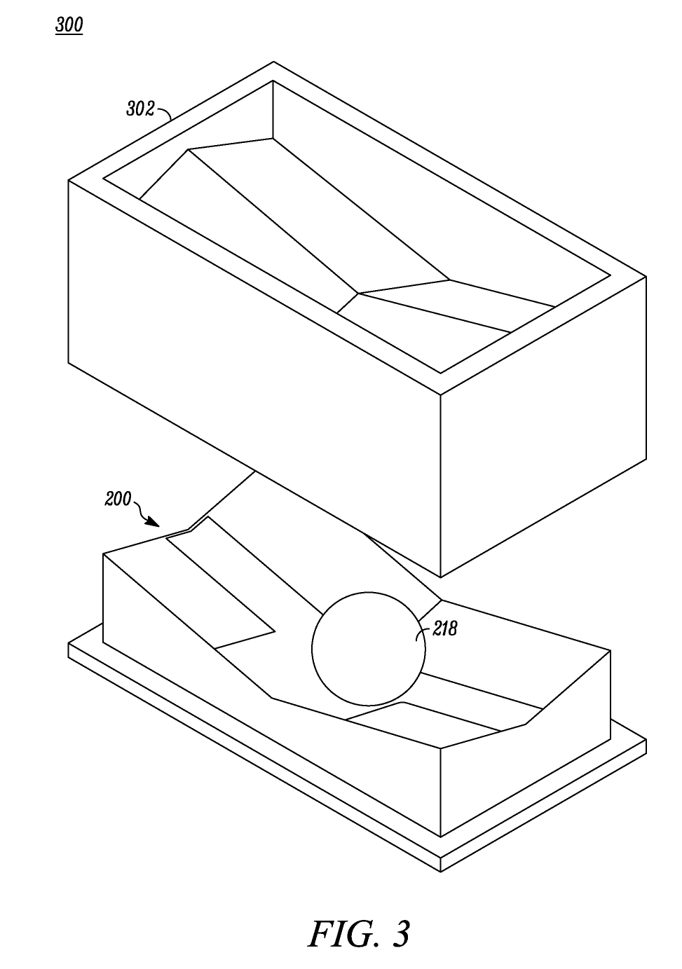

Operationally, an alternative inclinometer 200 as illustrated in FIG. 2 can include a conductive rolling ball 218 that touches electrical contacts 204 and 208 on a sloped surface 202 and further contacts a conductive area or surfaces 212 or 214 as a common contact on a second sloped surface 210 to complete a circuit connection and/or indicate a direction. The inclinometer 200 can include a track with opposing conductive contacts that are normally open. When an apparatus having the inclinometer 200 is tilted side to side, the conductive ball rolls along the track and touches the contacts 204 or 208 to complete a circuit. When the inclinometer 200 is level, the ball 218 does not make contact with the conductive contacts because the ball rests at the low point of the housing in a non-conductive area or surface 206. The conductive area or surface 212 or 214 can be separated from the contacts 204 and 208 by a gap 216. Further note that the ball 218 can be dimpled or include depressions 219 to provide further friction between the ball 218 and the sloped surface 202.

Alternatively, when configured with a curved base and multiple contacts as illustrated in FIG. 1, the inclinometer can be variable and can indicate a degree of tilt. But as shown in FIG. 2, the inclinometer 200 can be configured as a simple single pole double throw switch where the ball rides on a linear inclined plane with a contact at each end. Note, two switches, oriented at right angles to each other, can also be used for X-Y planar orientation. As illustrated in FIG. 3, the inclinometer 200 including the conductive sphere or ball 218 can be encased in a housing 302 that further defines the path where the ball 218 can travel within an assembly 300 and can substantially limit the sphere member from deviating from the path or otherwise substantially maintain the sphere member in electrical contact with at least one of the conductive members and the common contact. With further refinement and additional contacts, embodiments with sloped surfaces (whether curved, concave, linear parabolic, elliptical, conic or having other patterns defined by an equation or otherwise) can enable the measurement of a degree of tilt without requiring additional electronics to measure current or capacitance. Embodiments as illustrated using a ball are simply closing different switch contacts.

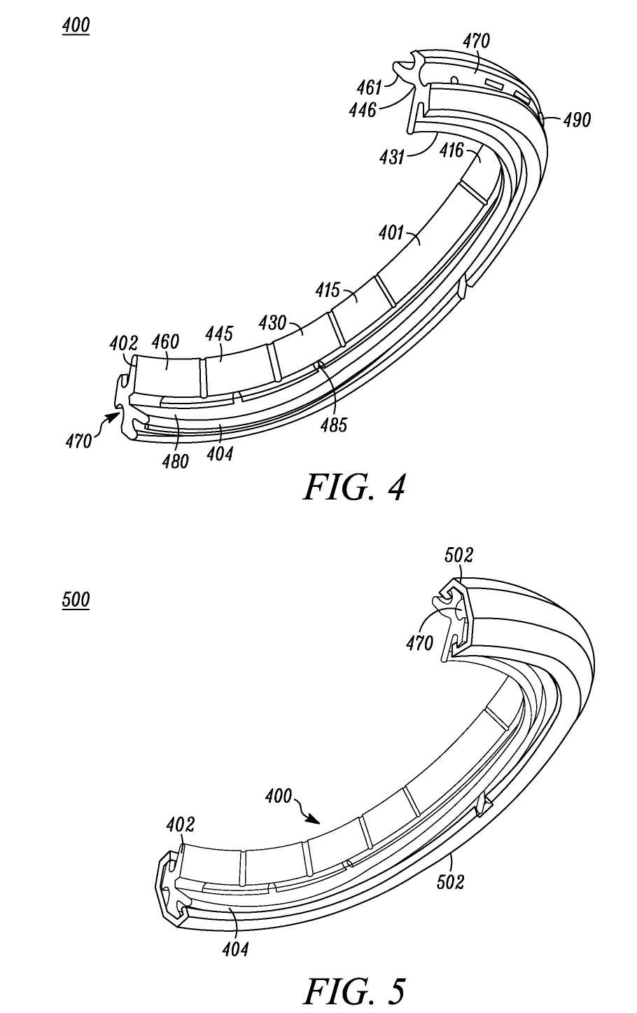

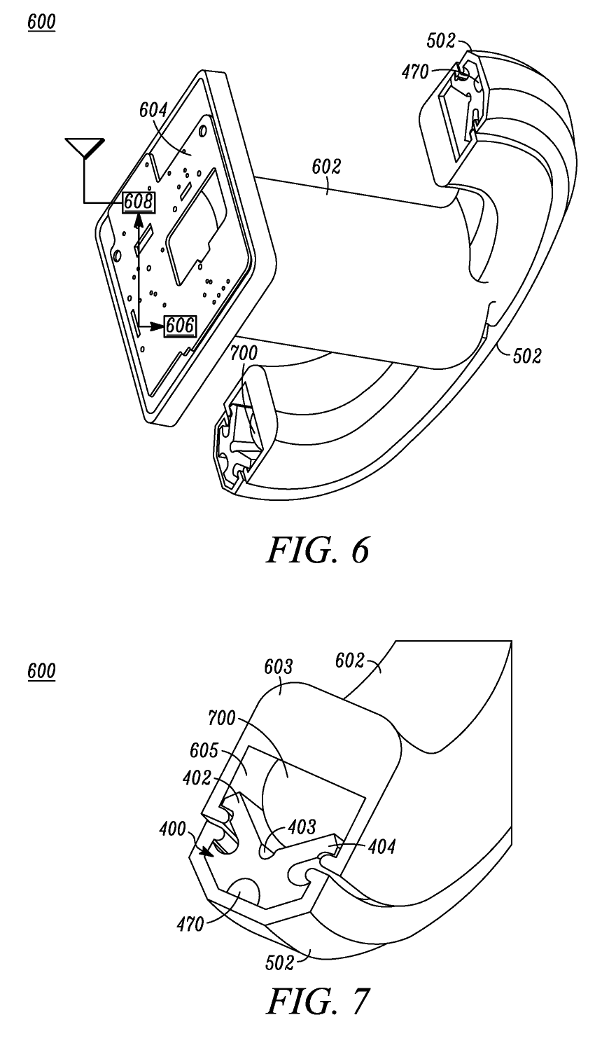

Referring to FIG. 4, an interior portion 400 of an inclinometer is shown. The portion 400 can include a sloped surface 402 having at least one conductive portion 460 and 461 on opposing sides of the sloped surface 402, and a second sloped surface 404 having a common contact 480 separate from the at least one conductive portion. The at least one conductive portion can be a plurality of conductive areas or surfaces 401, 415, 430, 445, 460, 416, 431, 446, and 461 corresponding to tilt degrees of 0, 15, 30, 45, and 60 respectively in a left orientation and 0, 15, 30, 45, and 60 respectively in a right orientation. The portion 400 can further include a groove 470 for carrying an electrical connection scheme such as a wire harness 490. The wires from the wire harness 490 can contact the various conductive areas via apertures or holes 485 in the groove 470 (and 403, see FIG. 7). An external portion of the portion 400 as well as the wire harness 490 can be covered by a wire harness cover 502 to form the assembly 500 as illustrated in FIG. 5. As further illustrated in FIG. 6, a remote controller or assembly 600 can further include a housing 602 that mates with the portion 400 enclosing the portion 400 and a conductive substantially spherical member or ball 700 therein. Note, the electrical connection scheme can be any coupling scheme enabling the detection of the separate plurality of conductive areas with the common contact 480 and is not necessarily limited to a wire harness. As noted before, the conductive substantially spherical member does not necessarily need to be a ball or sphere, but can come in any number of shapes (such as a spool shape, tube or roller) that traverses (e.g., rolls, slides, glides, etc.) the sloped surface providing the functions described herein.

The ball 700 can traverse the sloped surface 402 (see FIGS. 4 & 5). The conductive substantially spherical element 700 forms a connection between the common contact 480 and the at least one conductive portion (460, 445, 430, 415, 401, 416, 431, 446, 461) as it traverses the sloped surface 402. The conductive substantially spherical element 700 can be dimpled or shaped or formed to add additional friction as it traverses the sloped surface 402. The sloped surface can be a curved surface having a plurality of conductive portions along the curved surface and the second sloped surface 404 can be a curved surface having a conductive surface 480 thereon forming the common contact.

The remote controller 600 and corresponding assemblies as shown in FIGS. 4 through 7 can be viewed as including the assembly portion 400 or a first housing portion 400 holding the at least one conductive portion (460, 445, 430, 415, 401, 416, 431, 446, 461) and the common contact 480 and a second housing portion 602 which defines a path for the conductive substantially spherical member 700 to traverse when the first housing portion 400 and the second housing portion 602 are mated. The second housing portion 602 can optionally include a surface 605 creating friction upon the conductive substantially spherical member 700 as it traverses the path. The surface 605 can be an inner sidewall of the second housing portion 602 that can include felt or other material that can dampen the movement of the member 700. The movement of the ball 700 can be restricted at the extreme ends of the sloped surface 402 by a wall 603 formed in the second housing portion 602.

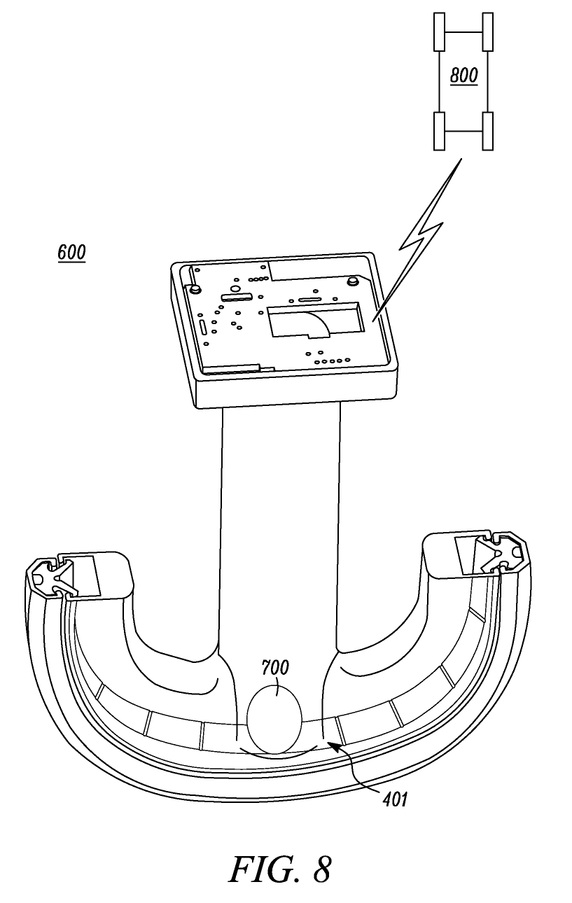

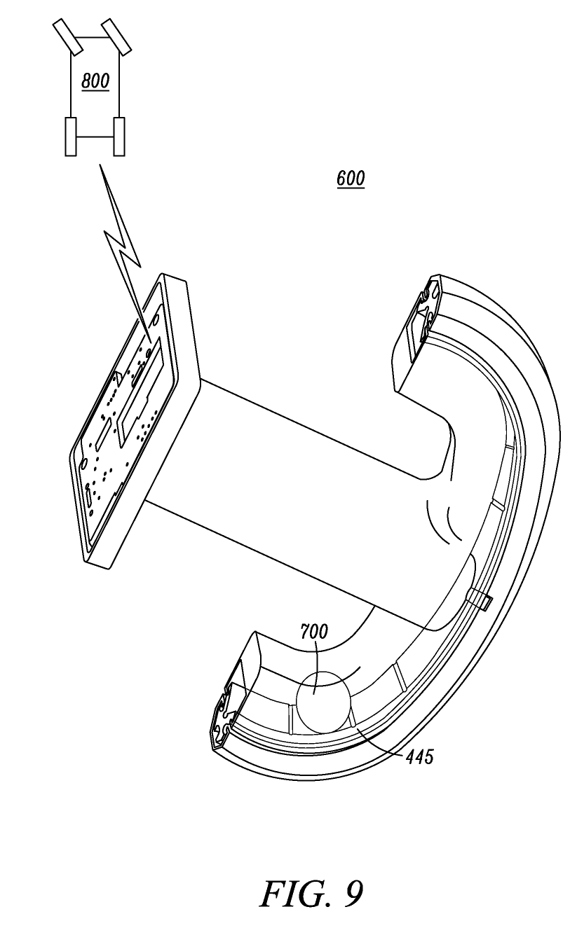

The inclinometer or controller 600 can further include a printed circuit board 604 having a controller 606 coupled to the plurality of conductive portions and the common contact 480. The connections between select portions of the plurality of conductive portions and the common contact 480 creates an indication of a degree of tilt recognizable by the controller 480. The wire harness 490 (FIG. 4) can provide a coupling between the controller 606 and the plurality of conductive portions and the common contact. Further note that the remote controller 600 can include a transmitter 608 coupled to the controller 606. As noted before, the controller 606 can be coupled to the plurality of conductive portions and the common contact where connections between select portions of the plurality of conductive portions and the common contact creates an indication of a degree of tilt recognizable by the controller 606. The transmitter 608 can transmit the indication of the degree of tilt to a remote controlled device 800 as shown in FIGS. 8 and 9 to cause the remote controlled device to operate in correspondence with the indication of the degree of tilt. As illustrated in FIG. 9, the remote controller 600 is tilted to the left 45 degrees and the remote controlled device 800 has its wheels tilted a corresponding 45 degrees to the left. The more contacts that are used in the sloped surface 402 the greater degree of granularity or refinement that can be used to control the remote controlled device 800.

Note that the remote controller or inclinometer 600 can be used in phones to control remote controlled devices as well as in dedicated remote controllers. As noted above, the inclinometer 600 can be used in numerous applications such as personal digital assistants, electronic books, laptop computers, and cell phones and can replace expensive gyroscopes, accelerometers or inertial switches in many applications. The sloped surfaces discussed herein can be linear, curved, concave, parabolic, elliptical, conic or have other various forms or patterns for measuring a degree of tilt or in a simple form serving as on/off switch.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. An inclinometer, comprising:
a sloped surface having at least one conductive portion on opposing sides of the sloped surface;
a second sloped surface having a common contact separate from the at least one conductive portion; and
a conductive substantially spherical member that traverses the sloped surface;
wherein the conductive substantially spherical element forms a connection between the common contact and the at least one conductive portion as it traverses the sloped surface.

2. The inclinometer of claim 1, wherein the sloped surface is a curved surface having a plurality of conductive portions along the curved surface.

3. The inclinometer of claim 1, wherein the second sloped surface is a curved surface having a conductive surface thereon forming the common contact.

4. The inclinometer of claim 1, wherein the inclinometer further comprises a housing having a first housing portion holding the at least one conductive portion and the common contact and a second housing portion which defines a path for the conductive substantially spherical member to traverse when the first housing portion and the second housing portion are mated.

5. The inclinometer of claim 4, wherein the second housing portion further comprises a surface creating friction upon the conductive substantially spherical member as it traverses the path.

6. The inclinometer of claim 1, wherein the inclinometer is used as an input device for either an electronic device comprising a remote controlled device controller where a user tilts the inclinometer to remotely operate a remote controlled device or a navigation tool for a personal digital assistant, a satellite navigation device, an electronic book, a laptop computer or a cellular phone where a user can tilt the inclinometer to turn pages, scroll through a map, or traverse through menus on the electronic device.

7. The inclinometer of claim 2, wherein the inclinometer further comprises a controller coupled to the plurality of conductive portions and the common contact, wherein connections between select portions of the plurality of conductive portions and the common contact creates an indication of a degree of tilt recognizable by the controller.

8. The inclinometer of claim 7, wherein an electrical connection scheme provides a coupling between the controller and the plurality of conductive portions and the common contact.

9. The inclinometer of claim 8, wherein the inclinometer further comprises a wire harness cover for a wire harness serving as the electrical connection scheme.

10. A remote controller for controlling a remote controlled device, comprising:
a transmitter;
a controller coupled to the transmitter;
a sloped surface having at least one conductive portion on opposing sides of the sloped surface;
a second sloped surface having a common contact separate from the at least one conductive portion; and
a conductive substantially spherical member that traverses the sloped surface;
wherein the conductive substantially spherical element forms a connection between the common contact and the at least one conductive portion as it traverses the sloped surface.

11. The remote controller of claim 10, wherein the sloped surface is a curved surface having a plurality of conductive portions along the curved surface and the second sloped surface is a curved surface having a conductive surface thereon forming the common contact.

12. The remote controller of claim 11, wherein the controller is coupled to the plurality of conductive portions and the common contact, wherein connections between select portions of the plurality of conductive portions and the common contact creates an indication of a degree of tilt recognizable by the controller.

13. The remote controller of claim 10, wherein the remote controller further comprises a housing having a first housing portion holding the at least one conductive portion and the common contact and a second housing portion which defines a path for the conductive substantially spherical member to traverse when the first housing portion and the second housing portion are mated.

14. The remote controller of claim 13, wherein the second housing portion further comprises a surface creating friction upon the conductive substantially spherical member as it traverses the path.

15. The remote controller of claim 10, wherein the conductive substantially spherical element is dimpled.

16. The remote controller of claim 12, wherein a wire harness provides a coupling between the controller and the plurality of conductive portions and the common contact.

17. A remote controlled system having a remote controller for controlling a remote controlled device, comprising:
a transmitter;
a controller coupled to the transmitter;
a sloped surface having a plurality of conductive portions along a side of the sloped surface;
a second sloped surface having a common contact separate from the plurality of conductive portions; and
a conductive substantially spherical member that traverses the sloped surface and the second sloped surface;
wherein the conductive substantially spherical element forms a connection between the common contact and select portions of the plurality of conductive portions as it traverses the sloped surface.

18. The remote controlled system of claim 17, wherein the controller is coupled to the plurality of conductive portions and the common contact, wherein connections between select portions of the plurality of conductive portions and the common contact creates an indication of a degree of tilt recognizable by the controller.

19. The remote controlled system of claim 18, wherein the transmitter transmits the indication of the degree of tilt to the remote controlled device to cause the remote controlled device to operate in correspondence with the indication of the degree of tilt.

20. The remote controlled system of claim 17, wherein the remote controller further comprises a housing having a first housing portion holding the plurality of conductive portions and the common contact and a second housing portion which defines a path for the conductive substantially spherical member to traverse when the first housing portion and the second housing portion are mated.
